(19) United States
(12) Patent Application Publication
(10) Pub. No.: US 2024/0292225 A1
(43) Pub. Date: Aug. 29, 2024

(54) NON-ACCESS STRATUM TRAFFIC ANALYSIS

(71) Applicant: Telefonaktiebolaget LM Ericsson (publ), Stockholm (SE)

(72) Inventors: Zhang FU, Stockholm (SE); Pinar COMAK, Ankara (TR); Ferhat KARAKOC, Istanbul (TR)

(73) Assignee: Telefonaktiebolaget LM Ericsson (publ), Stockholm (SE)

(21) Appl. No.: 18/693,448

(22) PCT Filed: Sep. 8, 2022
(86) PCT No.: PCT/EP2022/074989

§ 371 Date: Mar. 19, 2024

Related U.S. Application Data
(60) Provisional application No. 63/246,011, filed on Sep. 20, 2021.

(51) Int. Cl. H04W 12/122; H04W 12/72; H04W 12/76

(52) U.S. Cl. CPC H04W 12/122; H04W 12/72; H04W 12/76

(57) ABSTRACT

A method performed by a first network function is provided. The method comprises receiving a request for Non-Access Stratum (NAS) traffic information. The request was transmitted by a second network function. The method further comprises after receiving the request, sending towards the second network function a report comprising: i) a NAS message type identifier identifying a type of NAS message and information indicating a number of received NAS messages of the identified type and/or ii) user equipment (UE) type information indicating a type of UE and information indicating a number of NAS messages transmitted by UEs of the indicated type.

### TECHNICAL FIELD

This disclosure relates to methods and apparatus for Non-Access Stratum (NAS) traffic analysis.

### BACKGROUND

NAS traffic analysis can be used to, among other things, detect a Denial-of-Service (DOS) attack. A DOS attack is an attempt by an adversary to overwhelm a service and thereby prevent the legitimate users of a service from using that service. Generally speaking, any attack that can saturate or exhaust system resources or get the system into fault status, sometimes even crashes, can be identified as a DOS attack.

DOS attacks are usually launched in a distributed way: the attack traffic is from many attacking sources and the aggregated traffic volume is so big that it can easily deplete the victim's key computing resources such as bandwidth and CPU time. When the adversary compromises multiple machines to launch a DOS attack, this becomes a Distributed DoS (DDOS) attack.

There are several types of DDOS attacks. One type of DDOS attacks is a brute force DDOS attack. Brute force DDOS attacks aim to exhaust the victim's network bandwidth or computing resources by means of flooding massive malicious packets.

To deplete the victim's computation resources, the adversary usually uses the packets of Internet protocols that have a request-reply scheme such as the Transmission Control Protocol (TCP) and Hypertext Transfer Protocol (HTTP). During the attacks, massive spurious requests are flooded to keep the target busy serving the requests, thereby impeding the legitimate usage.

To deplete the bandwidth, the adversary can basically flood any type of packet to congest the target network link. Examples of such data packet flooding are User Datagram Protocol (UDP) flooding and Internet Control Message Protocol (ICMP) flooding.

A Network Data Analytics Function (NWDAF) may be used to detect such DDOS attacks.

NWDAF may be configured to offer automatic network analytics and alarming with possible capabilities of artificial intelligence (AI) and machine learning (ML) to help proactive management of the network (e.g., a Third Generation Partnership Project (3GPP) fifth generation (5G) network). The network analytics and alarming functions of the NWDAF may be used to detect cyber-attacks by monitoring events and data packets transmitted by user equipments (UEs) with support of ML algorithms.

To achieve cyber-attacks detection, the NWDAF can collaborate with a UE and any other NFs to collect related data as inputs. After collecting the related data, the NWDAF may provide alerts of anomaly events as outputs to an Operation, Administration, Maintenance (OAM) agent and other Network Functions (NFs) which have subscribed to them so that the OAM agent and other NFs can take proper actions in response to the alerts of the anomaly events.

The NWDAF may be capable of detecting different kinds of cyber-attacks. In order to mitigate the identified cyber-attacks, the data/parameters collected by NWDAF need to be studied. The specific cyber-attacks for which an analytics function of the NWDAF may provide detection support include but are not limited to the following examples:
(1) Man-In-The-Middle (MitM) attacks on the radio interface: MitM attacks or fraudulent relay nodes may modify or change messages between a UE and a RAN, resulting in failures of higher layer protocols such as NAS or the primary authentication. The NWDAF may detect MitM attacks; and
(2) DOS attacks: 5G has high performance requirements for system capacity and data rate, and improved capacity and higher data rate may lead to much higher processing capability cost for network entities, which may make some network entities (e.g., Radio Access Network (RAN), Core Network Entities) to suffer from DDOS attack. The NWDAF may also enable the detection of DDOS attacks.

The data included in Table 1 below may be collected for detecting DDOS attacks against the 3GPP 5G Access and Mobility Management function (AMF). Table 1 shows network analysis framework for DDOS attack.

| DDoS Attack | | Analysis | | |
|---|---|---|---|---|
| Target | Method | Input | Output | Mitigation |
| AF | DDoS using | AF: GPSI, external group | DDoS to AF | PCF may |
| | heavy UP | ID, Exception information | | request SMF to |
| | traffic | (IP address 5-tuple, | | release the PDU |
| | | exception ID, exception | | session. |
| | | level, and exception trend), | | SMF may |
| | | Application ID, | | release the PDU |
| | | communication description | | session and |
| | | per application | | apply SM back- |
| | | (communication start, | | off timer. |
| | | communication stop, UL | | |
| | | data rate, DL data rate, | | |
| | | traffic volume), Expected | | |
| | | UE Behaviour parameters | | |
| | | SMF: SUPI, internal group | | |
| | | ID, Application ID | | |
| | | UPF: UE communication | | |
| | | description per application | | |
| | | (communication start, | | |
| | | communication stop, UL | | |
| | | data rate, DL data rate, | | |
| | | traffic volume) | | |
| | | AMF: TAC | | |
| RAN | DDoS using | OAM: Global RAN Node | DDoS to RAN | AMF may |
| | heavy RRC | ID, time stamp, SUPI, | Victim RAN | provide AMF |
| | signaling | initial RRC message | Node ID | UE N2AP ID |
| | | number | Malicious SUPI | and RAN UE |
| | | AMF: Global RAN Node | | N2AP ID to |
| | | ID, time stamp, SUPI, | | RAN of |
| | | initial NAS message | | malicious SUPI. |
| | | number | | RAN may treat |
| | | | | the malicious |
| | | | | UEs based on |
| | | | | local policy, e.g. |
| | | | | release its |
| | | | | resource. |
| AMF | DDoS using | OAM: Global RAN Node | DDoS to AMF | AMF may treat |
| | heavy NAS | ID, time stamp, SUPI, | Victim AMF | the malicious |
| | signaling | initial RRC message | instance ID | UEs based on |
| | | number | Malicious SUPI | local policy, e.g. |
| | | AMF: AMF instance ID, | | release its |
| | | Global RAN Node ID, time | | resource. |
| | | stamp, SUPI, initial NAS | | |
| | | message number, initial SM | | |
| | | message number | | |

### SUMMARY

Certain problems exist for detecting DOS attacks. One of the problems is falsely detecting certain data traffic as a DOS attack. Such false detection may be caused by different variations of DOS attacks.

DOS attacks against an AMF may vary greatly. For example, one type of DOS attack involves a malicious UE that issues many bogus UE registration messages with a wrong Subscription Concealed Identifier (SUCI), thereby keeping AMF busy with resolving the wrong SUCI to obtain a Subscription Permanent Identifier (SUPI).

Another type of DOS attack involves a malicious UE that issues many Protocol Data Unit (PDU) session modification/establishment messages to the AMF, thereby keeping both the AMF and one or more SMFs busy with modifying PDU sessions. All such message may trigger heavy operations for NFs.

Due to the various types of DOS attacks, simply counting the number of NAS messages from a UE alone may not be enough to detect a DOS attack. For example, because some UEs may send multiple PDU session modification messages to join multiple MBS sessions (i.e., sending multiple PDU session modification messages is a normal operation for such UE), the fact that a UE sent multiple PDU session modification messages alone is not enough to establish that a DOS attack has occurred or is in progress.

Another example is a sidelink relaying scenario in which a relay UE sends a remote UE reporting message for each remote UE for which the relay provides its relay services. In such case, the relay UE's transmission of multiple remote UE reporting messages for multiple remote UEs does not constitute a DOS attack.

Accordingly, in one aspect, there is provided a method performed by a first network function (NEF, AF, AMF, OAM, SMF, etc.). The method comprises receiving a request for Non-Access Stratum (NAS) traffic information. The request was transmitted by a second network function (e.g., NWDAF). The method further comprises after receiving the request, sending towards the second network function a report comprising: i) a NAS message type identifier identifying a type of NAS message and information indicating a number of received NAS messages of the identified type and/or ii) user equipment (UE) type information (e.g., information about capability, UE model, UE vendor, etc.) indicating a type of UE and information indicating a number of NAS messages transmitted by UEs of the indicated type.

In another aspect, there is provided a method performed by a first network function (e.g., NWDAF). The method comprises transmitting towards a second network function (NEF, AF, AMF, OAM, SMF, etc.) a request for Non-Access Stratum (NAS) traffic information and after transmitting the request, receiving a report comprising: i) a NAS message type identifier identifying a type of NAS message and information indicating a number of received NAS messages of the identified type and/or ii) user equipment (UE) type information (e.g., information about capability, UE model, UE vendor, etc.) indicating a type of UE and information indicating a number of NAS messages transmitted by UEs of the indicated type. The report was sent by the second network function.

In other aspect, there is provided a method performed by a first network function (e.g., NWDAF). The method comprises determining that a user equipment, UE, is faulty or malicious; and after the determining, sending towards the second network function a notification indicating that the UE is determined to be faulty or malicious. The notification includes a UE identifier allocated to the UE by a RAN node or a core network control plane function (e.g., AMF) (e.g., the UE ID is a RAN UE NGAP ID or AMF UE NGAP ID).

In other aspect, there is provided a method performed by a first network function (NEF, AF, AMF, OAM, SMF, etc.). The method comprises receiving a notification indicating that the UE is determined to be faulty or malicious. The notification includes a UE identifier allocated to the UE by a RAN node or a core network control plane function (e.g., AMF) (e.g., the UE ID is a RAN UE NGAP ID or AMF UE NGAP ID), and the notification was sent by the second network function.

In other aspect, there is provided a method performed by a first network function (e.g., NWDAF). The method comprises receiving a report comprising NAS traffic information associated with a particular type of UE and/or a particular type of NAS message and using the NAS traffic information, building a NAS traffic profile for the particular type of UE and/or the particular type of NAS message. The report was sent by a second network function (NEF, AF, AMF, OAM, SMF, etc.), and the NAS traffic profile contains statistical (e.g., dispersion) information about NAS traffic for the particular type of UE and/or the particular type of NAS message.

In other aspect, there is provided a computer program comprising instructions which when executed by processing circuitry cause the processing circuitry to perform the method of any one of the embodiments described above.

In other aspect, there is provided a first network function. The first network function is configured to receive a request for Non-Access Stratum (NAS) traffic information, wherein the request was transmitted by a second network function (e.g., NWDAF) and after receiving the request, sending towards the second network function a report comprising: i) a NAS message type identifier identifying a type of NAS message and information indicating a number of received NAS messages of the identified type and/or ii) user equipment (UE) type information (e.g., information about capability, UE model, UE vendor, etc.) indicating a type of UE and information indicating a number of NAS messages transmitted by UEs of the indicated type.

In other aspect, there is provided a first network function. The first network function is configured to transmit towards a second network function (NEF, AF, AMF, OAM, SMF, etc.) a request for Non-Access Stratum (NAS) traffic information and after transmitting the request, receiving a report comprising: i) a NAS message type identifier identifying a type of NAS message and information indicating a number of received NAS messages of the identified type and/or ii) user equipment (UE) type information (e.g., information about capability, UE model, UE vendor, etc.) indicating a type of UE and information indicating a number of NAS messages transmitted by UEs of the indicated type. The report was sent by the second network function.

In other aspect, there is provided a first network function. The first network function is configured to determine that a user equipment, UE, is faulty or malicious; and after the determining, sending towards the second network function a notification indicating that the UE is determined to be faulty or malicious. The notification includes a UE identifier allocated to the UE by a RAN node or a core network control plane function (e.g., AMF) (e.g., the UE ID is a RAN UE NGAP ID or AMF UE NGAP ID).

In other aspect, there is provided a first network function. The first network function is configured to receive a notification indicating that the UE is determined to be faulty or malicious. The notification includes a UE identifier allocated to the UE by a RAN node or a core network control plane function (e.g., AMF) (e.g., the UE ID is a RAN UE NGAP ID or AMF UE NGAP ID), and the notification was sent by the second network function.

In other aspect, there is provided a first network function. The first function is configured to receive a report comprising NAS traffic information associated with a particular type of UE and/or a particular type of NAS message and using the NAS traffic information, build a NAS traffic profile for the particular type of UE and/or the particular type of NAS message. The report was sent by a second network function (NEF, AF, AMF, OAM, SMF, etc.), and the NAS traffic profile contains statistical (e.g., dispersion) information about NAS traffic for the particular type of UE and/or the particular type of NAS message.

In other aspect, there is provided an apparatus. The apparatus comprises a memory and processing circuitry coupled to the memory. The apparatus is configured to perform the method of any one of the embodiments described above.

Embodiments of this disclosure allow correctly detecting a DOS attack.

### BRIEF DESCRIPTION OF THE DRAWINGS

The accompanying drawings, which are incorporated herein and form part of the specification, illustrate various embodiments.

FIG. 1 illustrates a process according to some embodiments.

FIG. 2 illustrates a process according to some embodiments.

FIG. 3 illustrates a process according to some embodiments.

FIG. 4 illustrates a process according to some embodiments.

FIG. 5 illustrates a process according to some embodiments.

FIG. 6 illustrates a process according to some embodiments.

FIG. 7 illustrates an apparatus according to some embodiments.

### DETAILED DESCRIPTION

As noted above, presently there are challenges with respect to correctly identifying a DoS attack. In order to reduce false DOS attack detection, it is useful, for example, for an AMF to reports the type of NAS message(s) to NWDAF for correct DoS detection. Therefore, in some embodiments of this disclosure, an AMF may send to an NWDAF a report that identifies a NAS message type and identifies the number of NAS message of that identified type that have been received within a reporting period. The report may include per-UE NAS traffic information. That is, the report may include a UE identifier and NAS traffic information associated with the UE identifier (e.g., a plurality of tuples, where each tuple includes a NAS message type identifier and a corresponding value that indicates, for example, the total number of NAS message of that NAS message type that were transmitted by the UE within the reporting period. The report may also include information about the UE (e.g., capability information) such that the NWDAF can build a finer profile for UE NAS traffic pattern. Furthermore, when a UE attacks the AMF using a bogus registration message with a fake SUCI, the UE ID that the AMF includes in the report may be a RAN UE New Generation Application Protocol (NGAP) ID or AMF UE NGAP ID.

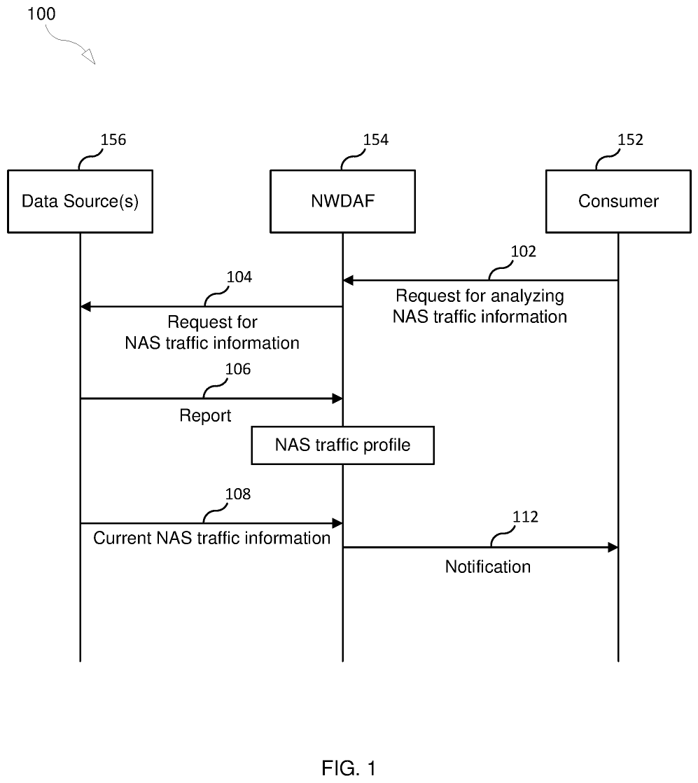

FIG. 1 shows a process 100 related to determining whether a group of one or more UEs is faulty or malicious, according to some embodiments. Process 100 may begin with a consumer 152 sending towards a NWDAF 154 a request 102 for analyzing NAS traffic information. Consumer 152 may be, for example, any one of Network Exposure Function (NEF), Application Function (AF), AMF, or Operations, Administrations, and Maintenance (OAM). The request may trigger NWDAF 154 to provide to consumer 152 a notification indicating whether a group of one or more UEs is determined to be faulty or malicious.

After receiving the request 102, NWDAF 154 may send towards at least one data source 156 a request 104 for Non-Access Stratum (NAS) traffic information. The request 104 may be a one-time request for data source 156 to provide NAS traffic information to NWDAF 154 once or a subscription request for data source 156 to provide NAS traffic information periodically (e.g., every 10 minutes) or upon an occurrence of a particular condition. Data source 156 may include any one or a combination of NEF, AF, AMF, or OAM.

Even though FIG. 1 shows that the consumer 152 and data source 156 are different entities, in some embodiments, they may be the same entity.

The request 104 for NAS traffic information may comprise any one or more of (i) a UE identifier (e.g., a Subscription Permanent Identifier (SUPI) or a Globally Unique Temporary Identifier (GUTI)) identifying a particular UE, (ii) a UE group identifier identifying a particular group of UEs, or (iii) no UE identifier (or an UE identifier of “ANY”) to indicate that NWDAF want to obtain NAS traffic information regardless of which UE sent the NAS traffic. One example of the UE group identifier is a Tracking Area (TA) identifier identifying an area in which UEs are located.

After receiving the request 104 for NAS traffic information, data source 156 may begin to (i) collect historical and/or real time NAS traffic information (e.g., NAS traffic information associated with the identified UE and/or the identified group of UEs), and (ii) send a report 106 containing NAS traffic information. Alternatively, data source 156 may already have collected NAS traffic information associated with a plurality of UEs at the time of receiving the request 104. In such case, as a result of receiving the request 104, data source 156 merely create the report 106 using the previously collected NAS traffic information and send the report 106 towards NWDAF 154.

The report 106 may comprise (i) a NAS message type identifier identifying a type of NAS message and information indicating a number of received NAS messages of the identified type, (ii) UE type information indicating a type of UE and information indicating a number of NAS messages transmitted by UEs of the indicated type, and/or (iii) a combination of this information. For example, the table below illustrates the information that may be included in the report according to some embodiments:

UE ID = ABC123; UE type = Type123

| | Message count value (total number of |
|---|---|
| NAS Message Type | message or average message frequency) |
| NAS_type_1 | 12 |
| NAS_type_2 | 5 |

As shown in the table above, in one embodiment, the report 106 may include information (e.g., a count value) indicating a number of NAS messages of a particular type, which were transmitted by UEs of a particular type. In a different embodiment, however, the report 106 may include information indicating a number of NAS messages of a particular type, which were transmitted by any UE.

The type of NAS message identified in the report 106 may be any one of a UE registration request, a Protocol Data Unit (PDU) session establishment request, a PDU session modification request, or a remote UE report.

The UE type information may comprise UE capability information (e.g., information indicating that a UE was serving as a relay UE), a UE model identifier (e.g., information indicating a particular model of a UE-iPhone™ 11 pro), and/or a UE vendor identifier (e.g., information indicating a maker of a UE-Apple™).

The UE ID may be a UE Next Generation Application Protocol (NGAP) identifier (ID) (e.g., a Radio Access Node UE NGAP ID or an AMF UE NGAP ID), a SUPI, or a GUTI. In addition, the report 106 may additionally include an AMF identifier identifying the AMF that generated the message.

The NAS messages of which the number is indicated in the report 106 (as shown above in the tables) are the NAS messages transmitted by UE(s) that are identified by the UE identifier or the group of UE identifiers included in the request 104. For instance, as shown in the table above (and assuming that the message count value is in units of messages), within the reporting period (e.g., within the last X minutes), UE ABC123 transmitted 12 NAS messages of type NAS_type_1 within the reporting period. Assuming the message count value is in unites of messages per minute and the reporting period is 2 minutes, then the report indicates that UE ABC123 transmitted 24 NAS message of type NAS_type_1 within 2 minutes.

After receiving the report 106, NWDAF 154 may build a NAS traffic profile using the information included in the report. The NAS traffic profile may contain statistical information about NAS message traffic for the particular type of UE (identified in the request 104) and/or the particular type of NAS message (identified in the request 104).

Tables 1-3 below show simplified examples of the NAS traffic profile.

TABLE 1

| | |
|---|---|
| NAS message type 1 | # of type 1 NAS messages that can be sent |
| NAS message type 2 | # of type 2 NAS messages that can be sent |

TABLE 2

| | |
|---|---|
| UE type 1 | # of NAS messages that can be sent by a UE of type 1 |
| UE type 2 | # of NAS messages that can be sent by a UE of type 2 |

TABLE 3

| | | |
|---|---|---|
| UE | NAS message | # of type 1 NAS messages that can |
| type 1 | type 1 | be sent by a UE of type 1 |
| UE | NAS message | # of type 2 NAS messages that can |
| type 2 | type 2 | be sent by a UE of type 2 |

In some embodiments, the NAS traffic profile may include the maximum number of UE reports a relay UE may send during a given time interval or a number of Multicast Broadcast Services (MBS) sessions a UE (e.g., particular type of UE) may join.

Even though FIG. 1 shows that the three steps—NWDAF 154's transmission of the request 104 for NAS traffic information, data source 156's transmission of the report 106, and NWDAF 154's building of the NAS traffic profile—occur after NWDAF 154 receives from consumer 152 the request 102 for analyzing NAS traffic information, the three steps may occur before NWDAF 154 receives from consumer 152 the request 102.

After NWDAF 154 built the NAS traffic profile, in some scenarios, NWDAF 154 may receive (current) NAS traffic information 108 associated with a particular UE or a particular group of UEs. In such scenarios, NWDAF 154 may analyze the received NAS traffic information 108 to determine whether the UE or the group of UEs is faulty or malicious and send a notification 112 indicating the result of the analysis.

For example, if an analysis of the NAS traffic information indicates that a UE of a particular type transmitted N (a positive integer) number of NAS messages during a given time interval while the NAS traffic profile indicates that a UE of the particular type generally transmits M (a positive integer-which is less than N by more than a threshold value) number of NAS messages during the given time interval, NWDAF may determine that the is faulty or malicious and send towards consumer 102 the notification 112 indicating that the UE is faulty or malicious.

The notification 112 may include a UE identifier that is only identifiable by one or more particular network functions (e.g., AMF). Examples of such UE identifier include RAN UE New Generation Application Protocol (NGAP) ID or AMF UE NGAP ID.

After receiving the notification 112, consumer 152 may send towards the UE that was determined to be faulty or malicious a message notifying the UE that the UE was determined to be faulty or malicious. In some embodiments, the message may trigger the UE to change its configuration as to NAS message signaling.

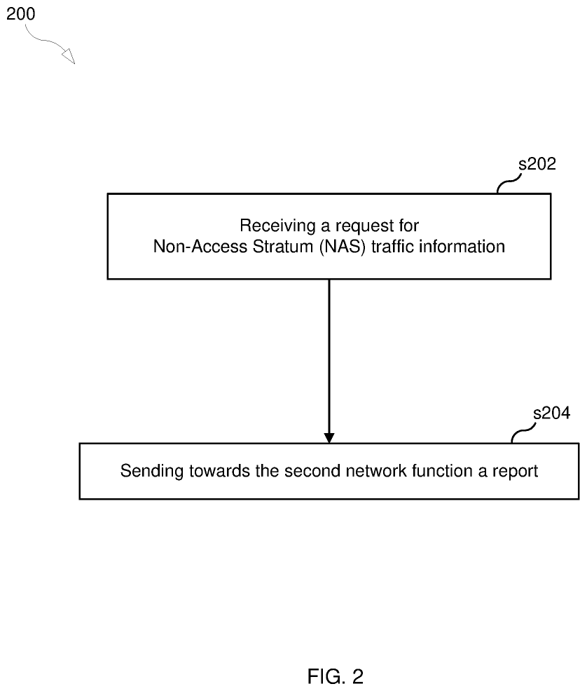

FIG. 2 shows a process 200 performed by a first network function (NEF, AF, AMF, OAM, SMF, etc.). Process 200 may begin with step s202. Step s202 comprises receiving a request for Non-Access Stratum (NAS) traffic information, wherein the request was transmitted by a second network function (e.g., NWDAF). Step s204 comprises after receiving the request, sending towards the second network function a report comprising: i) a NAS message type identifier identifying a type of NAS message and information indicating a number of received NAS messages of the identified type and/or ii) user equipment (UE) type information (e.g., information about capability, UE model, UE vendor, etc.) indicating a type of UE and information indicating a number of NAS messages transmitted by UEs of the indicated type.

In some embodiments, the request for NAS traffic information is either a one-time request to provide the report once or a subscription request to provide a report periodically or upon an occurrence of a particular condition.

In some embodiments, the request for NAS traffic information comprises a UE identifier identifying a particular UE and/or a UE group identifier identifying a group of UEs (e.g., TA identifier identifying an area in which UEs are located).

In some embodiments, the NAS messages of the identified type and/or the NAS messages transmitted by UEs of the indicated type comprise NAS messages transmitted by the identified UE and/or the identified group of UEs.

In some embodiments, process 200 further comprises collecting historical and/or real time NAS traffic information associated with the identified UE and/or the identified group of UEs.

In some embodiments, the identified type of NAS message is one of a UE registration request, a Protocol Data Unit (PDU) session establishment request, a PDU session modification request, or a remote UE report.

In some embodiments, the UE type information comprises UE capability information, a UE model identifier, and/or a UE vendor identifier.

In some embodiments, the report further comprises any one or a combination of: an AMF identifier identifying a particular AMF, a UE Next Generation Application Protocol (NGAP) identifier (ID), wherein the UE NGAP ID is a Radio Access Node UE NGAP ID or an AMF UE NGAP ID, a Subscription Permanent Identifier (SUPI), or a Globally Unique Temporary Identifier (GUTI).

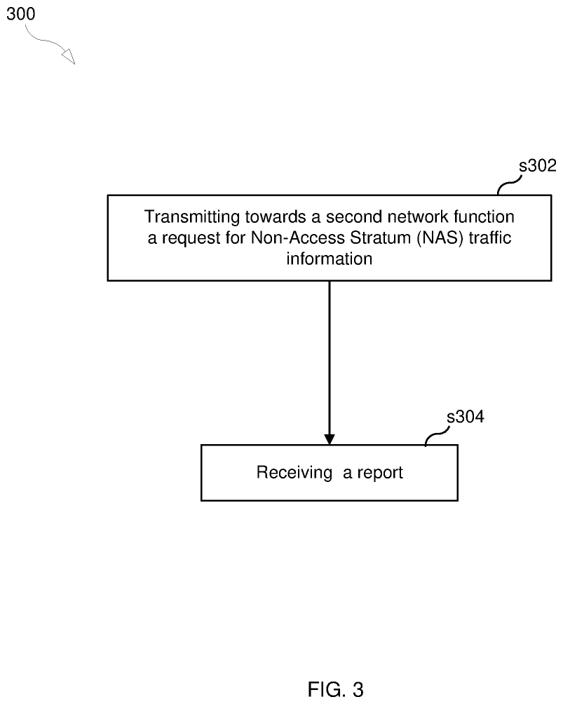

FIG. 3 shows a process 300 performed by a first network function (e.g., NWDAF). Process 300 may begin with step s302. Step s302 comprises transmitting towards a second network function (NEF, AF, AMF, OAM, SMF, etc.) a request for Non-Access Stratum (NAS) traffic information. Step s304 comprises after transmitting the request, receiving a report comprising: i) a NAS message type identifier identifying a type of NAS message and information indicating a number of received NAS messages of the identified type and/or ii) user equipment (UE) type information (e.g., information about capability, UE model, UE vendor, etc.) indicating a type of UE and information indicating a number of NAS messages transmitted by UEs of the indicated type. The report was sent by the second network function.

In some embodiments, the request for NAS traffic information is either a one-time request to provide the report once or a subscription request to provide a report periodically or upon an occurrence of a particular condition.

In some embodiments, the request for NAS traffic information comprises a UE identifier identifying a particular UE and/or a UE group identifier identifying a group of UEs (e.g., TA identifier identifying an area in which UEs are located).

In some embodiments, the NAS messages of the identified type and/or the NAS messages transmitted by UEs of the indicated type comprise NAS messages transmitted by the identified UE and/or the identified group of UEs.

In some embodiments, the identified type of NAS message is one of a UE registration request, a Protocol Data Unit (PDU) session establishment request, a PDU session modification request, or a remote UE report.

In some embodiments, the UE type information comprises information about UE capability information, a UE model identifier, and/or a UE vendor identifier.

In some embodiments, the report further comprises any one or a combination of: an AMF identifier identifying a particular AMF, a UE Next Generation Application Protocol (NGAP) identifier (ID), wherein the UE NGAP ID is a Radio Access Node UE NGAP ID or an AMF UE NGAP ID, a Subscription Permanent Identifier (SUPI), or a Globally Unique Temporary Identifier (GUTI).

In some embodiments, process 300 further comprises collecting historical and/or real NAS traffic information associated with the identified UE and/or the identified group of UEs; and building a NAS traffic profile, wherein the NAS traffic profile contains statistical (e.g., dispersion) information about NAS message traffic for the particular type of UE and/or the particular type of NAS message.

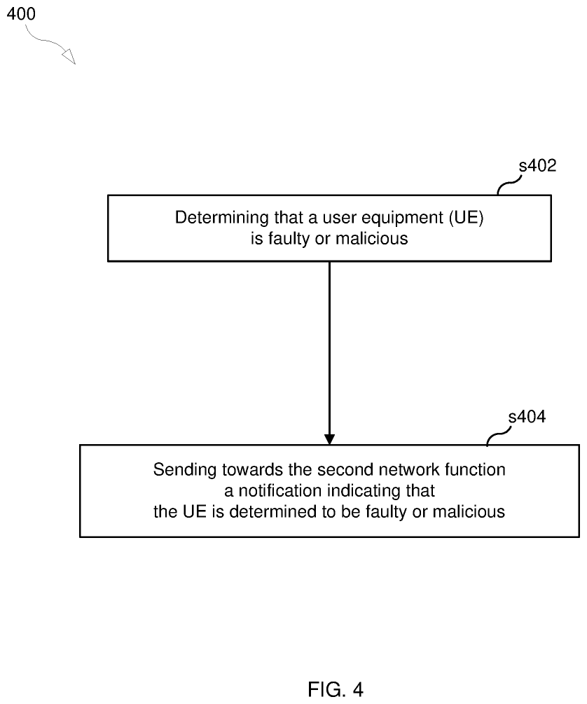

FIG. 4 shows a process 400 performed by a first network function (e.g., NWDAF). Process 400 may begin with step s402. Step s402 comprises determining that a user equipment, UE, is faulty or malicious. Step s404 comprises after the determining, sending towards the second network function a notification indicating that the UE is determined to be faulty or malicious, wherein the notification includes a UE identifier allocated to the UE by a RAN node or a core network control plane function (e.g., AMF) (e.g., the UE ID is a RAN UE NGAP ID or AMF UE NGAP ID).

In some embodiments, process 400 further comprises receiving NAS traffic information associated with UEs, using a NAS traffic profile, analyzing the received NAS traffic information, and as a result of analyzing the received NAS traffic information, determining whether a UE is faulty or malicious, wherein the NAS traffic profile contains statistical (e.g., dispersion) information about NAS message traffic for the particular type of UE and/or the particular type of NAS message.

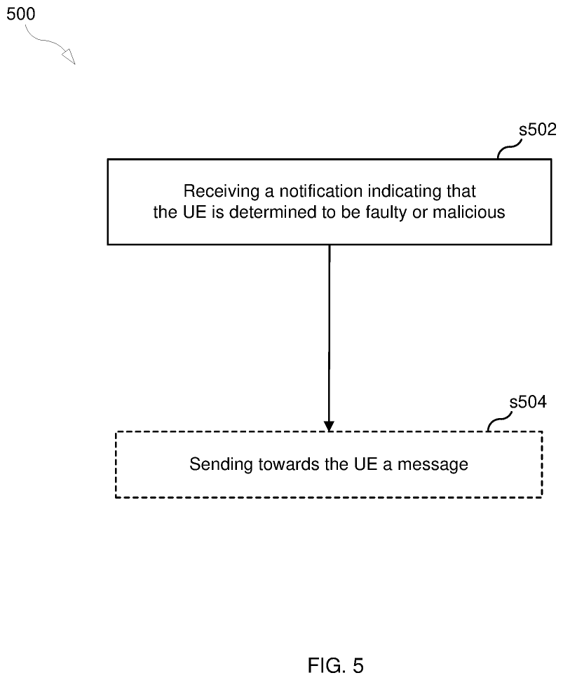

FIG. 5 shows a process 500 performed by a first network function (NEF, AF, AMF, OAM, SMF, etc.). Process 500 comprises step s502. Step s502 comprises receiving a notification indicating that the UE is determined to be faulty or malicious. The notification includes a UE identifier allocated to the UE by a RAN node or a core network control plane function (e.g., AMF) (e.g., the UE ID is a RAN UE NGAP ID or AMF UE NGAP ID), and the notification was sent by the second network function.

In some embodiments, process 500 further comprises an optional step s504. Step s504 comprises, in response to receiving the notification, sending towards the UE a message (e.g., alert indicating to the UE that there is a problem).

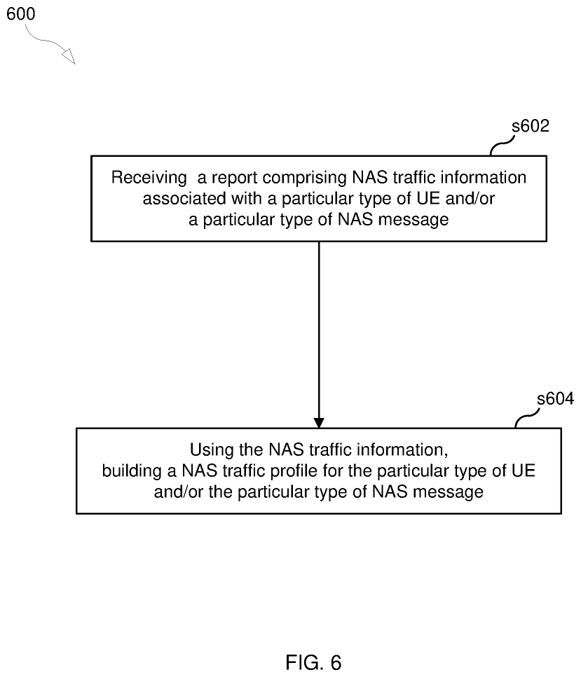

FIG. 6 shows a process 600 performed by a first network function (e.g., NWDAF). Process 600 may begin with step s602. Step s602 comprises receiving a report comprising NAS traffic information associated with a particular type of UE and/or a particular type of NAS message. Step s604 comprises using the NAS traffic information, building a NAS traffic profile for the particular type of UE and/or the particular type of NAS message. The report was sent by a second network function (NEF, AF, AMF, OAM, SMF, etc.), the NAS traffic profile contains statistical (e.g., dispersion) information about NAS traffic for the particular type of UE and/or the particular type of NAS message.

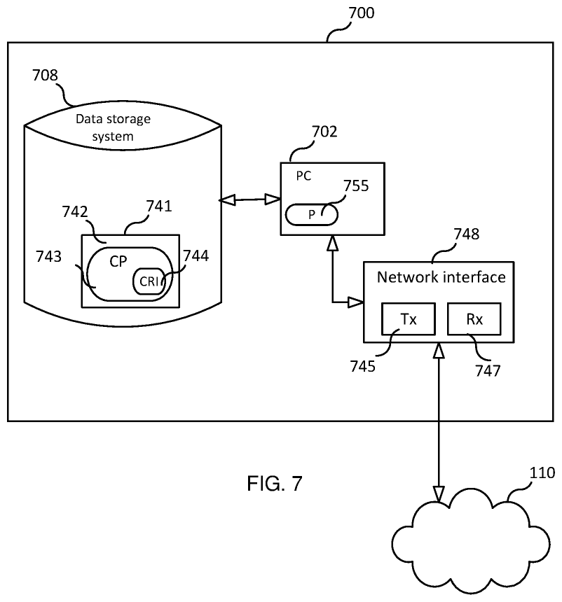

FIG. 7 is a block diagram of an apparatus 700, according to some embodiments, for implementing various network entities (NWDAF, NEF, AF, AMF, OAM, SMF, etc.) described above. As shown in FIG. 7, apparatus 700 may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 700 may be a distributed computing apparatus); a network interface 748 comprising a transmitter (Tx) 745 and a receiver (Rx) 747 for enabling apparatus 700 to transmit data to and receive data from other nodes connected to a network 110 (e.g., an Internet Protocol (IP) network) to which network interface 748 is connected (directly or indirectly) (e.g., network interface 748 may be wirelessly connected to the network 110, in which case network interface 748 is connected to an antenna arrangement); and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes apparatus 700 to perform steps described herein (e.g., steps described herein with reference to the flow charts). In other embodiments, apparatus 700 may be configured to perform steps described herein without the need for code. That is, for example, PC 702 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a first network function, the method comprising:
receiving a request for Non-Access Stratum (NAS) traffic information, wherein the request was transmitted by a second network function; and
after receiving the request, sending towards the second network function a report comprising: i) a NAS message type identifier identifying a type of NAS message and information indicating a number of received NAS messages of the identified type and/or ii) user equipment (UE) type information indicating a type of UE and information indicating a number of NAS messages transmitted by UEs of the indicated type.

2. The method of claim 1, wherein the request for NAS traffic information is either a one-time request to provide the report once or a subscription request to provide a report periodically or upon an occurrence of a particular condition.

3. The method of claim 1, wherein the request for NAS traffic information comprises a UE identifier identifying a particular UE and/or a UE group identifier identifying a group of UEs.

4. The method of claim 3, wherein the NAS messages of the identified type and/or the NAS messages transmitted by UEs of the indicated type comprise NAS messages transmitted by the identified UE and/or the identified group of UEs.

5. The method of claim 1, the method further comprising:
collecting historical and/or real time NAS traffic information associated with the identified UE and/or the identified group of UEs.

6. The method of claim 1, wherein the identified type of NAS message is one of a UE registration request, a Protocol Data Unit (PDU) session establishment request, a PDU session modification request, or a remote UE report.

7. The method of claim 1, wherein the UE type information comprises UE capability information, a UE model identifier, and/or a UE vendor identifier.

8. The method of claim 1, wherein the report further comprises any one or a combination of:
an AMF identifier identifying a particular AMF,
a UE Next Generation Application Protocol (NGAP) identifier (ID), wherein the UE NGAP ID is a Radio Access Node UE NGAP ID or an AMF UE NGAP ID,
a Subscription Permanent Identifier (SUPI), or
a Globally Unique Temporary Identifier (GUTI).

9. A method performed by a first network function, the method comprising:
transmitting towards a second network function a request for Non-Access Stratum (NAS) traffic information; and
after transmitting the request, receiving a report comprising: i) a NAS message type identifier identifying a type of NAS message and information indicating a number of received NAS messages of the identified type and/or ii) user equipment (UE) type information indicating a type of UE and information indicating a number of NAS messages transmitted by UEs of the indicated type, wherein
the report was sent by the second network function.

10. The method of claim 9, wherein the request for NAS traffic information is either a one-time request to provide the report once or a subscription request to provide a report periodically or upon an occurrence of a particular condition.

11. The method of claim 9, wherein the request for NAS traffic information comprises a UE identifier identifying a particular UE and/or a UE group identifier identifying a group of UEs.

12. The method of claim 11, wherein the NAS messages of the identified type and/or the NAS messages transmitted by UEs of the indicated type comprise NAS messages transmitted by the identified UE and/or the identified group of UEs.

13. The method of claim 9, wherein the identified type of NAS message is one of a UE registration request, a Protocol Data Unit (PDU) session establishment request, a PDU session modification request, or a remote UE report.

14. The method of claim 9, wherein the UE type information comprises information about UE capability information, a UE model identifier, and/or a UE vendor identifier.

15. The method of claim 9, wherein the report further comprises any one or a combination of:
an AMF identifier identifying a particular AMF,
a UE Next Generation Application Protocol (NGAP) identifier (ID), wherein the UE NGAP ID is a Radio Access Node UE NGAP ID or an AMF UE NGAP ID,
a Subscription Permanent Identifier (SUPI), or
a Globally Unique Temporary Identifier (GUTI).

16. The method of claim 9, the method further comprising:
collecting historical and/or real NAS traffic information associated with the identified UE and/or the identified group of UEs; and
building a NAS traffic profile, wherein
the NAS traffic profile contains statistical information about NAS message traffic for the particular type of UE and/or the particular type of NAS message.

17-23. (canceled)

24. A first network function comprising:
a memory; and
processing circuitry coupled to the memory, wherein
the first network function is configured to:
receive a request for Non-Access Stratum (NAS) traffic information, wherein the request was transmitted by a second network function;
after receiving the request, send towards the second network function a report comprising: i) a NAS message type identifier identifying a type of NAS message and information indicating a number of received NAS messages of the identified type and/or ii) user equipment (UE) type information indicating a type of UE and information indicating a number of NAS messages transmitted by UEs of the indicated type.

25. (canceled)

26. A first network function comprising:
a memory; and
processing circuitry coupled to the memory, wherein
the first network function is configured to:
transmit towards a second network function a request for Non-Access Stratum (NAS) traffic information;
after transmitting the request, receive a report comprising: i) a NAS message type identifier identifying a type of NAS message and information indicating a number of received NAS messages of the identified type and/or ii) user equipment (UE) type information indicating a type of UE and information indicating a number of NAS messages transmitted by UEs of the indicated type, wherein
the report was sent by the second network function.

27-33. (canceled)
